(19) United States
(12) Patent Application Publication
(10) Pub. No.: US 2025/0219680 A1
(43) Pub. Date: Jul. 3, 2025

(54) METHOD FOR DETERMINING BEAM INFORMATION, AND APPARATUS

(71) Applicant: BEIJING XIAOMI MOBILE SOFTWARE CO., LTD., Beijing (CN)

(72) Inventor: Liangang CHI, Beijing (CN)

(73) Assignee: BEIJING XIAOMI MOBILE SOFTWARE CO., LTD., Beijing (CN)

(21) Appl. No.: 18/850,479

(22) PCT Filed: Mar. 31, 2022
(86) PCT No.: PCT/CN2022/084656

§ 371 Date: Sep. 24, 2024

(51) Int. Cl. H04B 7/04; H04B 7/06; H04L 5/00

(52) U.S. Cl. CPC H04B 7/04013; H04B 7/06952; H04L 5/0005

(57) ABSTRACT

Disclosed is a method for determining beam information. The method includes: receiving beam capability information sent by an auxiliary communication device, the auxiliary communication device being at least one of: a smart repeater, or a Reconfigurable Intelligence Surface (RIS); and sending beam configuration information to the auxiliary communication device.

### CROSS REFERENCE TO RELATED APPLICATION

The present application is the U.S. National Stage Application of International Application No. PCT/CN2022/084656, filed on Mar. 31, 2022, the contents of which are incorporated herein by reference in its entirety for all purposes.

### FIELD

The present disclosure relates to the communication technical field, and in particular to a beam information determination method and apparatus.

### BACKGROUND

With the continuous developments of communication technologies, the requirements for communication quality are getting increasingly high. Generally, the wireless environment is an uncontrollable factor in traditional communications. Its uncontrollability usually has a negative effect on communication efficiency and reduces service quality. For example, signal attenuation limits the propagation distance of wireless signals, and multipath effects, reflection and refraction of large objects may cause the fading of wireless signals.

In related art, in order to improve communication performance, a smart repeater and a Reconfigurable Intelligence Surface (RIS) may be used to increase the strength of a received signal and improve transmission performance between communication devices. In order to give full play to the enhancement effect of the smart repeater and the RIS on communication performance, beam measurement and management need to be enhanced.

### SUMMARY

Embodiments of the present disclosure provide a beam information determination method and apparatus.

In a first aspect, an embodiment of the present disclosure provides a beam information determination method. The method is performed by a network device, and the method includes:
receiving beam capability information sent by an auxiliary communication device, wherein the auxiliary communication device is at least one of: a smart repeater, or a Reconfigurable Intelligence Surface (RIS); and
sending beam configuration information to the auxiliary communication device.

In a second aspect, an embodiment of the present disclosure provides a beam information determination method. The method is performed by an auxiliary communication device, and the method includes:
sending beam capability information to a network device, wherein the auxiliary communication device is at least one of: a smart repeater, or a Reconfigurable Intelligence Surface (RIS); and
receiving beam configuration information sent by the network device.

In a third aspect, an embodiment of the present disclosure provides a beam information determination method. The method is performed by a terminal device, and the method includes:

receiving reference signal configuration information sent by a network device, wherein the configuration of the reference signal is determined by the network device based on beam capability information of an auxiliary communication device; and

measuring the reference signal specified in the reference signal configuration information.

In a fourth aspect, an embodiment of the present disclosure provides a communication apparatus, applied at a network device side. The apparatus includes:

a transceiving module configured to receive beam capability information sent by an auxiliary communication device, wherein the auxiliary communication device is at least one of: a smart repeater, or a Reconfigurable Intelligence Surface (RIS);

where the transceiving module is further configured to send beam configuration information to the auxiliary communication device.

In a fifth aspect, an embodiment of the present disclosure provides a communication apparatus, applied at an auxiliary communication device side. The apparatus includes:

a transceiving module configured to send beam capability information to a network device, wherein the auxiliary communication device is at least one of: a smart repeater, or a Reconfigurable Intelligence Surface (RIS);

where the transceiving module is further configured to receive the beam configuration information sent by the network device.

In a sixth aspect, an embodiment of the present disclosure provides a communication apparatus, applied at a terminal device side. The apparatus includes:

a transceiving module configured to receive reference signal configuration information sent by a network device, wherein the configuration of the reference signal is determined by the network device based on beam capability information of an auxiliary communication device; and

a processing module configured to measure the reference signal specified in the reference signal configuration information.

In a seventh aspect, an embodiment of the present disclosure provides a communication apparatus including a processor. When the processor calls a computer program in a memory, the method described in the first aspect is implemented.

In an eighth aspect, an embodiment of the present disclosure provides a communication apparatus including a processor. When the processor calls a computer program in a memory, the method described in the second aspect is implemented.

In a ninth aspect, an embodiment of the present disclosure provides a communication apparatus including a processor. When the processor calls a computer program in a memory, the method described in the third aspect is implemented.

In a tenth aspect, an embodiment of the present disclosure provides a communication apparatus, which includes a processor and a memory in which a computer program is stored. When the processor executes the computer program stored in the memory, the communication apparatus is caused to perform the method described in the first aspect above.

In an eleventh aspect, an embodiment of the present disclosure provides a communication apparatus, which includes a processor and a memory in which a computer program is stored. When the processor executes the computer program stored in the memory, the communication apparatus is caused to perform the method described in the second aspect above.

In a twelfth aspect, an embodiment of the present disclosure provides a communication apparatus, which includes a processor and a memory in which a computer program is stored. When the processor executes the computer program stored in the memory, the communication apparatus is caused to perform the method described in the third aspect above.

In a thirteenth aspect, an embodiment of the present disclosure provides a communication apparatus, which includes a processor and an interface circuit, wherein the interface circuit is configured to receive a code instruction and transmit it to the processor, and the processor is configured to run the code instruction to cause the apparatus to perform the method described in the first aspect above.

In a fourteenth aspect, an embodiment of the present disclosure provides a communication apparatus, which includes a processor and an interface circuit, wherein the interface circuit is configured to receive a code instruction and transmit it to the processor, and the processor is configured to run the code instruction to cause the apparatus to perform the method described in the second aspect above.

In a fifteenth aspect, an embodiment of the present disclosure provides a communication apparatus, which includes a processor and an interface circuit, wherein the interface circuit is configured to receive a code instruction and transmit it to the processor, and the processor is configured to run the code instruction to cause the apparatus to perform the method described in the third aspect above.

In a sixteenth aspect, an embodiment of the present disclosure provides a positioning system. The system includes the communication apparatus described in the fourth aspect, the communication apparatus described in the fifth aspect, and the communication apparatus described in the sixth aspect; or, the system includes the communication apparatus described in the seventh aspect, the communication apparatus described in the eighth aspect, and the communication apparatus described in the ninth aspect; or, the system includes the communication apparatus described in the tenth aspect, the communication apparatus described in the eleventh aspect, and the communication apparatus described in the twelfth aspect; or, the system includes the communication apparatus described in the thirteenth aspect, the communication apparatus described in the fourteenth aspect, and the communication apparatus described in the fifteenth aspect.

In a seventeenth aspect, an embodiment of the present disclosure provides a computer-readable storage medium for storing instructions for the above-mentioned terminal device. When the instructions are executed, the terminal device is caused to perform the method described in the first aspect.

In an eighteenth aspect, an embodiment of the present disclosure provides a readable storage medium for storing instructions used by the above-mentioned network device. When the instructions are executed, the network device is caused to perform the method described in the second aspect.

In a nineteenth aspect, an embodiment of the present disclosure provides a readable storage medium for storing instructions used by the above-mentioned network device. When the instructions are executed, the network device is caused to perform the method described in the third aspect.

In a twentieth aspect, the present disclosure further provides a computer program product including a computer program. When the computer program is run on a computer, the computer is caused to perform the method described in the first aspect.

In a twenty-first aspect, the present disclosure further provides a computer program product including a computer program. When the computer program is run on a computer, the computer is caused to perform the method described in the second aspect.

In a twenty-second aspect, the present disclosure further provides a computer program product including a computer program. When the computer program is run on a computer, the computer is caused to perform the method described in the third aspect.

In a twenty-third aspect, the present disclosure provides a chip system. The chip system includes at least one processor and an interface, for supporting a network device to implement the functions involved in the first aspect, for example, determining or processing at least one of data and information involved in the above method. In one possible design, the chip system further includes a memory, which is configured to store a computer program and data necessary for the network device. The chip system may be formed by a chip, or the chip system may include a chip and other discrete device(s).

In a twenty-fourth aspect, the present disclosure provides a chip system, which includes at least one processor and an interface, for supporting the auxiliary communication device to implement the functions involved in the second aspect, for example, determining or processing at least one of data and information involved in the above method. In one possible design, the chip system further includes a memory, which is configured to store a computer program and data necessary for the auxiliary communication device. The chip system may be formed by a chip, or the chip system may include a chip and other discrete device(s).

In a twenty-fifth aspect, the present disclosure provides a chip system, which includes at least one processor and an interface, for supporting a terminal device to implement the functions involved in the third aspect, for example, determining or processing at least one of data and information involved in the above method. In one possible design, the chip system further includes a memory, which is configured to store a computer program and data necessary for the terminal device. The chip system may be formed by a chip, or the chip system may include a chip and other discrete device(s).

In a twenty-sixth aspect, the present disclosure provides a computer program. When the computer program is run on a computer, the computer is caused to perform the method described in the first aspect.

In a twenty-seventh aspect, the present disclosure provides a computer program. When the computer program is run on a computer, the computer is caused to perform the method described in the second aspect.

In a twenty-eighth aspect, the present disclosure provides a computer program. When the computer program is run on a computer, the computer is caused to perform the method described in the third aspect.

### BRIEF DESCRIPTION OF THE DRAWINGS

In order to more clearly illustrate the technical solutions in the embodiments of the present disclosure or the background technology, the drawings required for use in the embodiments of the present disclosure or the background technology will be described below.

FIG. 1 is a schematic diagram of the architecture of a communication system provided by an embodiment of the present disclosure;

FIG. 2 is a schematic flowchart of a beam information determination method provided by an embodiment of the present disclosure;

FIG. 3 is a schematic flowchart of a beam information determination method provided by an embodiment of the present disclosure;

FIG. 4 is a schematic flowchart of a beam information determination method provided by an embodiment of the present disclosure;

FIG. 5 is a schematic flowchart of a beam information determination method provided by an embodiment of the present disclosure;

FIG. 6 is a schematic flowchart of a beam information determination method provided by an embodiment of the present disclosure;

FIG. 7 is a schematic flowchart of a beam information determination method provided by an embodiment of the present disclosure;

FIG. 8 is a schematic flowchart of a beam information determination method provided by an embodiment of the present disclosure;

FIG. 9 is a schematic flowchart of a beam information determination method provided by an embodiment of the present disclosure;

FIG. 10 is a schematic flowchart of a beam information determination method provided by an embodiment of the present disclosure;

FIG. 11 is a schematic diagram of the structure of a communication apparatus provided by an embodiment of the present disclosure;

FIG. 12 is a schematic diagram of the structure of another communication apparatus provided by an embodiment of the present disclosure;

FIG. 13 is a schematic diagram of the structure of a chip provided by an embodiment of the present disclosure.

### DETAILED DESCRIPTION

For ease of understanding, terms involved in the present disclosure are first introduced.

### 1. Smart Repeater

A smart repeater may be any network device that can at least directionally amplify signal(s), or a terminal device that has the function of directionally amplifying signal(s).

### 2. Reconfigurable Intelligence Surface (RIS)

The Reconfigurable Intelligence Surface (RIS) is also known as “reconfigurable smart surface” or “smart reflective surface”. From the appearance point of view, RIS is an ordinary thin sheet. However, it can be flexibly deployed in a wireless communication propagation environment and realize manipulation of features such as the frequency, phase, polarization and so on of reflected or refracted electromagnetic waves, thereby achieving the purpose of reshaping a wireless channel. Specifically, RIS can reflect a signal incident on its surface to a specific direction through a precoding technology, thereby enhancing the signal strength at the receiving end and realizing the control of the channel.

### 3. Beamforming

Beamforming, also known as beam forming or spatial filtering, is a signal processing technology that uses a sensor array to send and receive signals in a directional manner. The beamforming technology adjusts parameters of a basic unit of a phase array, so that signals at a certain angle obtain constructive interference, while signals at other angle(s) obtain destructive interference. Beamforming can be used at both a signal transmission end and a signal reception end.

In order to better understand a beam information determination method disclosed in an embodiment of the present disclosure, the communication system to which the embodiments of the present disclosure are applicable is first described below.

FIG. 1 is a schematic diagram of the architecture of a communication system provided by an embodiment of the present disclosure. The communication system may include but is not limited to a network device, an auxiliary communication device and a terminal device. The number and form of devices shown in FIG. 1 are only used for illustration and do not constitute a limitation on the embodiments of the present disclosure. In actual applications, two or more network devices, two or more auxiliary communication devices, and two or more terminal devices may be included. The communication system shown in FIG. 1 includes a network device 11, a terminal device 12 and an auxiliary communication device 13 as an example.

It should be noted that the technical solutions of the embodiments of the present disclosure may be applied to various communication systems, such as a Long Term Evolution (LTE) system, a fifth generation (5G) mobile communication system, a 5G New Radio (NR) system, or other future new mobile communication systems, and so on.

The network device 11 in the embodiment of the present disclosure is an entity at the network side for transmitting or receiving signals. For example, the network device 101 may be an evolved base station (evolved NodeB, eNB), a Transmission Reception Point (TRP), a next generation NodeB (gNB) in the NR system, a base station in other future mobile communication system(s), or an access node in a Wireless Fidelity (WiFi) system. The embodiment of the present disclosure does not limit the specific technology and specific device form adopted by the network device. The network device provided in the embodiment of the present disclosure may be formed by a Central Unit (CU) and a Distributed Unit (DU). The CU may also be referred to as a control unit. The CU-DU structure may be used to split the protocol layer(s) of the network device, such as a base station, and the functions of some protocol layers are placed in the CU for centralized control, and the functions of the remaining part or all of the protocol layers are distributed in the DU, and the DU is centrally controlled by the CU.

The terminal device 12 in the embodiment of the present disclosure is an entity at the user side for receiving or transmitting signals, such as a mobile phone. The terminal device may also be called a terminal, User Equipment (UE), a Mobile Station (MS), a Mobile Terminal (MT), etc. The terminal device may be a car with a communication function, a smart car, a mobile phone, a wearable device, a tablet computer (Pad), a computer with a wireless transceiver function, a Virtual Reality (VR) terminal device, an Augmented Reality (AR) terminal device, a wireless terminal device in industrial control, a wireless terminal device in self-driving, a wireless terminal device in remote medical surgery, a wireless terminal device in smart grid, a wireless terminal device in transportation safety, a wireless terminal device in smart city, a wireless terminal device in smart home, etc. The embodiment of the present disclosure does not limit the specific technology and specific device form adopted by the terminal device.

The auxiliary communication device 13 in the embodiment of the present disclosure may be any device that can assist communications between the terminal device 12 and the network device 11. For example, the auxiliary communication device 13 may be a smart repeater, or the auxiliary communication device 13 may also be a Reconfigurable Intelligence Surface (RIS), etc., and the present disclosure does not limit this.

The communication system described in the embodiments of the present disclosure is for the purpose of more clearly illustrating the technical solutions of the embodiments of the present disclosure, and does not constitute a limitation on the technical solutions provided by the embodiments of the present disclosure. With the evolutions of the system architecture and the emergence of new service scenarios, the technical solutions provided by the embodiments of the present disclosure are also applicable to similar technical problems.

Usually, a smart repeater and an RIS can only perform receiving, radio frequency conversion or forwarding of beams, but cannot shape beams, and cannot adjust beams for a specific area or a specific user. In the present disclosure, in order to improve communication performance, a smart repeater and an RIS can report their own beam capabilities to a network device, and then the network device can indicate to an auxiliary communication device the beams with better communication performance with a specific area or a specific user. Thus, the smart repeater and the RIS can perform communications according to a beam configured or indicated by the network device, which is beneficial to improving communication performance. The beam information determination method and apparatus provided in the present disclosure are described in detail below in conjunction with the accompanying drawings.

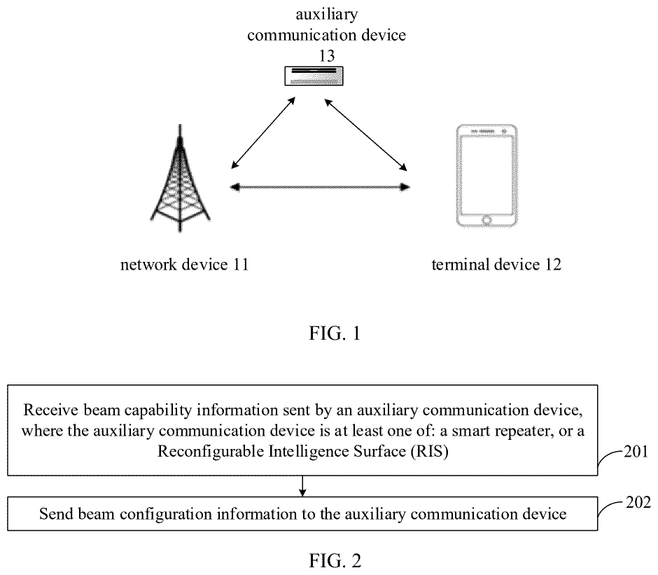

FIG. 2 is a flowchart of a beam information determination method provided by an embodiment of the present disclosure. The method is performed by a network device. As shown in FIG. 2, the method may include but is not limited to the following steps:

In step 201, beam capability information sent by an auxiliary communication device is received. The auxiliary communication device is at least one of: a smart repeater, or a Reconfigurable Intelligence Surface (RIS).

The beam capability information may include at least one of: information of an antenna panel or an RIS panel, a beam adjustment capability, the number of supported beams supported, and angle information of each supported beam, etc.

In addition, the information of the antenna panel or the RIS panel may include at least one of: direction information of the antenna panel or the RIS panel, such as the normal direction of the antenna panel or the RIS panel; array element arrangement information of the antenna panel or the RIS panel, etc. The array element arrangement information is used to describe the number of antenna array elements included in a first dimension and the number of antenna array elements included in a second dimension in an antenna panel array or an RIS panel array.

In some embodiments of the present disclosure, the beam adjustment capability may include at least one of: a frequency of beam adjustment, or time required to complete beam adjustment. The frequency of beam adjustment may indicate the tempo of the beam adjustment, and may include a static beam adjustment (i.e., beam adjustment is not supported), a semi-static beam adjustment (i.e., beam adjustment at a slower frequency), a dynamic beam adjustment (i.e., beam adjustment at a faster frequency), etc. For example, if the “frequency of beam adjustment” information is missing in the beam capability information, it may indicate that the auxiliary communication device does not have the capability of beam adjustment, or that the frequency of its beam adjustment is not fixed, etc., and the present disclosure does not limit this.

In the present disclosure, the network device may determine the direction of a beam that can be processed by the antenna panel or the RIS panel based on the normal direction of the antenna panel or the RIS panel and/or the array element arrangement information of the antenna panel or the RIS panel, and determine the duration required for the antenna panel or the RIS panel to perform beam adjust and transmission based on the frequency of the beam adjustment and/or the time required to complete the beam adjustment, thereby controlling the smart repeater or RIS to perform beam adjustment for a specific area or a specific user.

Generally, when a network device and a terminal device perform communications, a signal may undergo a series of complex procedures such as reflection, refraction, scattering, diffraction, penetration, and interference, etc., which may cause problems such as signal attenuation and reduce communication performance. In order to improve communication performance, an auxiliary communication device may be used to process the signal and then forward the signal to eliminate signal attenuation. When the auxiliary communication device forwards the signal, the beam direction of the transmitted signal is consistent with the direction of the terminal device, and the energy of the transmitted signal is concentrated in the same direction, the signal strength is the greatest and the communication performance is the best.

In the present disclosure, in order to enable the auxiliary communication device to have the capability to perform beam adjustment for different terminal devices, the intelligent auxiliary device can send its own beam capability information to the network device, so that the network device can determine in which direction the channel state of the beam of the auxiliary communication device is better according to the beam capability information. In this way, the auxiliary communication device can be used to perform beam forwarding for the terminal device in the same direction as the direction of the beam with good channel state. In addition, there can be one or more beams with better channel state.

In step 202, beam configuration information is sent to the auxiliary communication device.

The beam configuration information includes at least one of: information of a configured beam, reference signal configuration information, or association information between the reference signal and the configured beam.

In addition, the reference signal configuration information includes at least one of: an index of a reference signal, antenna port number of the reference signal, a time domain position occupied by the reference signal, or a frequency domain position occupied by the reference signal. The antenna port number of the reference signal may be used to uniquely identify a reference signal antenna port. The index of the reference signal may be used to uniquely identify the reference signal.

In the present disclosure, after receiving the beam capability information sent by the auxiliary communication device, the network device can determine multiple beams with better communication performance. After that, the network device can combine the multiple beams to determine configured beam(s), and configure a corresponding reference signal for each configured beam to determine the reference signal configuration information. Then, the network device can generate beam configuration information based on the information of the configured beam, the reference signal configuration information, and the association information between a reference signal and the configured beam, and send the beam configuration information to the auxiliary communication device. The auxiliary communication device can determine and send the corresponding reference signal based on the beam configuration information. The terminal device can receive the corresponding reference signal, measure each corresponding reference signal, and report the measurement result(s) to the network device. Therefore, the network device can determine the beam with the best channel status based on the measurement result(s), and indicate the auxiliary communication device to use the beam to perform communications, thereby improving the communication performance.

It can be understood that when the beams supported by the auxiliary communication device are combined to determine the configured beam(s), one configured beam may correspond to one beam supported by the auxiliary communication device, or one configured beam may correspond to one beam combination supported by the auxiliary communication device, and the present disclosure does not limit this.

In the present disclosure, after receiving the beam capability information sent by the auxiliary communication device, the network device can send beam configuration information to the auxiliary communication device. Thereafter, the auxiliary communication device can determine and send the corresponding reference signal according to the beam configuration information, so that the terminal device can measure the corresponding reference signal. Thus, the network device can determine the beam with the best channel state according to the measurement result(s) reported by the terminal device, and indicate the auxiliary communication device to perform communications using the beam. In this way, the auxiliary communication device has a self-adaptive beamforming capability, thereby further improving the communication performance.

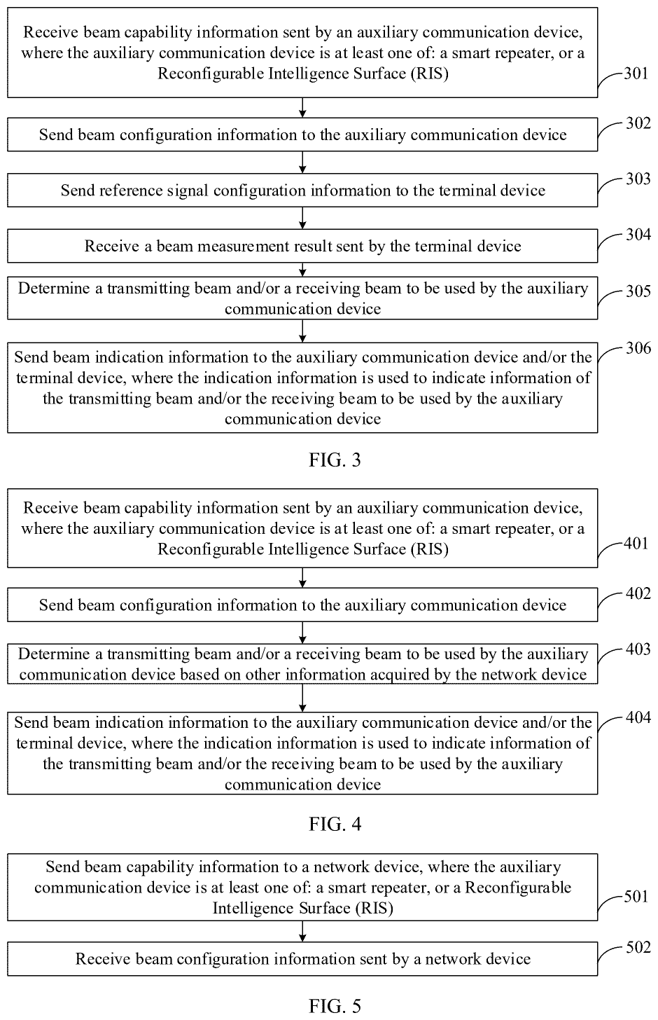

FIG. 3 is a flowchart of a beam information determination method provided by an embodiment of the present disclosure. The method is performed by a network device. As shown in FIG. 3, the method may include but is not limited to the following steps:

In step 301, beam capability information sent by an auxiliary communication device is received. The auxiliary communication device is at least one of: a smart repeater, or a Reconfigurable Intelligence Surface (RIS).

In step 302, beam configuration information is sent to the auxiliary communication device.

In the present disclosure, for the specific implementations of step 301 to step 302, reference may be made to the detailed description of any embodiment of the present disclosure, and repeated description will be omitted here.

In step 303, reference signal configuration information is sent to the terminal device.

In the present disclosure, after the network device configures the corresponding reference signal for each beam of the auxiliary communication device, the network device can also send the configuration information of each reference signal to the terminal device, and the terminal device can measure each reference signal to determine the beam with the best channel state.

In some embodiments of the present disclosure, the network device may directly send the reference signal configuration information to the terminal device, or the network device may alternatively send the reference signal configuration information to the terminal device through the auxiliary communication device, which is not limited in the present disclosure.

In step 304, a beam measurement result sent by the terminal device is received.

In the present disclosure, after receiving the reference signal configuration information, the terminal device can determine a corresponding reference signal according to the reference signal index information, and then measure each reference signal at the time-frequency domain position corresponding to the reference signal to determine the beam measurement result corresponding to each reference signal, and send the measurement result to the terminal device.

In step 305, a transmitting beam and/or a receiving beam to be used by the auxiliary communication device is determined.

In the present disclosure, the network device can determine the channel state corresponding to each beam based on the measurement result of each beam, and then determine the beam with the best channel state as the transmitting beam and/or the receiving beam to be used by the auxiliary communication device.

In step 306, beam indication information is sent to the auxiliary communication device and/or the terminal device. The indication information is used to indicate information of the transmitting beam and/or the receiving beam to be used by the auxiliary communication device.

The information of the beam to be used may be indicated by an associated reference signal, and the information of the beam to be used may include at least one of: an index of a reference signal, antenna port number of the reference signal, a time domain position occupied by the reference signal, or a frequency domain position occupied by the reference signal, etc. In addition, the information of the beam to be used may be consistent with reference signal configuration information corresponding to the beam.

In the present disclosure, after determining the information of the beam to be used, the network device can send indication information to the auxiliary communication device for indicating the transmitting beam and/or the receiving beam to be used by the auxiliary communication device. Thereafter, the auxiliary communication device can determine the beam to be used based on the beam indication information and the association information between the reference signal and the configured beam. Then, the auxiliary communication device can use the beam to perform communications and perform beamforming for the beam, thereby improving communication performance.

Alternatively, after determining the information of the beam to be used, the network device can send beam indication information to the terminal device for indicating the transmitting beam and/or the receiving beam to be used by the auxiliary communication device. Thereafter, the terminal device can perform reception and/or transmission based on the beam to be used, thereby improving communication performance.

In the present disclosure, after the network device receives the beam capability information sent by the auxiliary communication device, the network device can send beam configuration information to the auxiliary communication device, and then the network device can send reference signal configuration information to the terminal device and receive the beam measurement result(s) sent by the terminal device. Then, the transmitting beam and/or the receiving beam to be used by the auxiliary communication device can be determined, and beam indication information for indicating the transmitting beam and/or the receiving beam to be used by the auxiliary communication device can be sent to the auxiliary communication device. As a result, the network device can determine the beam with the best channel state through measurement based on the beam capability information sent by the auxiliary communication device, and indicate the auxiliary communication device to perform communications using the beam, thereby improving communication performance.

FIG. 4 is a flowchart of a beam information determination method provided by an embodiment of the present disclosure. The method is performed by a network device. As shown in FIG. 4, the method may include but is not limited to the following steps:

In step 401, beam capability information sent by an auxiliary communication device is received. The auxiliary communication device is at least one of: a smart repeater, or a Reconfigurable Intelligence Surface (RIS).

In step 402, beam configuration information is sent to the auxiliary communication device.

In the present disclosure, for the specific implementations of step 401 to step 402, reference may be made to detailed description of any embodiment of the present disclosure, and repeated description will be omitted here.

In step 403, a transmitting beam and/or a receiving beam to be used by the auxiliary communication device is determined based on other information acquired by the network device.

In the present disclosure, the network device may also obtain other information to determine the transmitting beam and/or the receiving beam to be used by the auxiliary communication device. For example, the network device may obtain position information of the terminal device, and then determine a beam consistent with the position direction of the terminal device as the transmitting beam and/or the receiving beam to be used by the auxiliary communication device.

In step 404, beam indication information is sent to the auxiliary communication device and/or the terminal device. The indication information is used to indicate information of the transmitting beam and/or the receiving beam to be used by the auxiliary communication device.

In the present disclosure, for the specific implementation of step 404, reference may be made the detailed description of any embodiment of the present disclosure, and repeated description will be omitted here.

In the present disclosure, after the network device receives the beam capability information sent by the auxiliary communication device, the network device can send beam configuration information to the auxiliary communication device. Thereafter, based on other information acquired by the network device, the network device can determine the transmitting beam and/or the receiving beam to be used by the auxiliary communication device, and send to the auxiliary communication device the beam indication information for indicating the transmitting beam and/or the receiving beam to be used by the auxiliary communication device. Thus, the network device can determine the beam with the best channel state according to the beam capability information sent by the auxiliary communication device, and indicate the auxiliary communication device to perform communications using the beam, thereby improving communication performance.

FIG. 5 is a flowchart of a beam information determination method provided by an embodiment of the present disclosure. The method is performed by an auxiliary communication device. As shown in FIG. 5, the method may include but is not limited to the following steps:

In step 501, beam capability information is sent to a network device. The auxiliary communication device is at least one of: a smart repeater, or a Reconfigurable Intelligence Surface (RIS).

The beam capability information may include at least one of: information of an antenna panel or an RIS panel, a beam adjustment capability, the number of supported beams, and angle information of each supported beam, etc.

In addition, the information of the antenna panel or the RIS panel may include at least one of: direction information of the antenna panel or the RIS panel, such as the normal direction of the antenna panel or RIS panel; array element arrangement information of the antenna panel or the RIS panel, etc. The array element arrangement information is used to describe the number of antenna array elements included in a first dimension and the number of antenna array elements included in a second dimension in an antenna panel array or an RIS panel array.

In some embodiments of the present disclosure, the beam adjustment capability may include at least one of: a frequency of beam adjustment, or time required to complete the beam adjustment. The beam adjustment frequency may indicate the tempo of the beam adjustment, and may include not supporting beam adjustment, supporting beam adjustment at a slower frequency, supporting fast frequency adjustment, etc. For example, if the “frequency of beam adjustment” information is missing in the beam capability information, it may indicate that the auxiliary communication device does not have the capability of beam adjustment, or that the frequency of its beam adjustment is not fixed, etc., and the present disclosure does not limit this.

In the present disclosure, the network device can determine the direction of a beam that can be processed by the antenna panel or the RIS panel based on the normal direction of the antenna panel or the RIS panel and/or the array element arrangement information of the antenna panel or the RIS panel, and determine the duration required for the antenna panel or the RIS panel to perform beam adjustment and transmission based on the frequency of the beam adjustment and/or the time required to complete the beam adjustment, thereby controlling the smart repeater or the RIS to perform beam adjustment for a specific area or a specific user.

Generally, when a network device and a terminal device perform communications, a signal may undergo a series of complex procedures such as reflection, refraction, scattering, diffraction, penetration, and interference, which may cause problems such as signal attenuation and reduce communication performance. In order to improve communication performance, an auxiliary communication device may be used to process the signal and then forward the signal to eliminate signal attenuation. When the auxiliary communication device forwards the signal, the beam direction corresponding to the transmitted signal is consistent with the direction of the terminal device, and when the energy of the transmitted signal is concentrated in the same direction, the signal strength is the greatest and the communication performance is the best.

In the present disclosure, in order to enable the auxiliary communication device to have the capability to perform beam adjustment for different terminal devices, the intelligent auxiliary device can send its own beam capability information to the network device, so that the network device can determine in which direction the channel state of the beam of the auxiliary communication device is better according to the beam capability information. In this way, the auxiliary communication device can be used to perform forwarding on the beam for the terminal device in the same direction as the direction of the beam with good channel state. In addition, there can be one or more beams with better channel state.

In step 502, beam configuration information sent by a network device is received.

The beam configuration information includes at least one of: information of a configured beam, reference signal configuration information, or association information between the reference signal and the configured beam.

In addition, the reference signal configuration information includes at least one of: an index of a reference signal, antenna port number of the reference signal, a time domain position occupied by the reference signal, or a frequency domain position occupied by the reference signal. The antenna port number of the reference signal can be used to uniquely identify a reference signal antenna port. The index of the reference signal can be used to uniquely identify the reference signal.

In the present disclosure, after receiving the beam capability information sent by the auxiliary communication device, the network device can determine multiple beams with better communication performance. After that, the network device can combine the multiple beams to determine configured beam(s), and configure a corresponding reference signal for each configured beam to determine the reference signal configuration information. Then, the network device can generate beam configuration information based on the information of the configured beam, the reference signal configuration information, and the association information between the reference signal and the configured beam, and send this beam configuration information to the auxiliary communication device. The auxiliary communication device can determine and send the corresponding reference signal based on the beam configuration information. The terminal device can receive the corresponding reference signal, measure each corresponding reference signal, and report the measurement result(s) to the network device. Therefore, the network device can determine the beam with the best channel state based on the measurement result(s), and indicate the auxiliary communication device to use the beam to perform communications, thereby improving the communication performance.

It can be understood that when the beams supported by the auxiliary communication device are combined to determine the configured beam(s), one configured beam may correspond to one beam supported by an auxiliary communication device, or one configured beam may correspond to one beam combination supported by an auxiliary communication device, and the present disclosure does not limit this.

In the present disclosure, after sending the beam capability information to the network device, the auxiliary communication device can receive the beam configuration information sent by the network device. Thereafter, the auxiliary communication device can determine and send the corresponding reference signal according to the beam configuration information, so that the terminal device can measure the corresponding reference signal. Thus, the network device can determine the beam with the best channel state according to the measurement result(s) reported by the terminal device, and indicate the auxiliary communication device to perform communications using the beam. In this way, the auxiliary communication device has a self-adaptive beamforming capability, thereby further improving the communication performance.

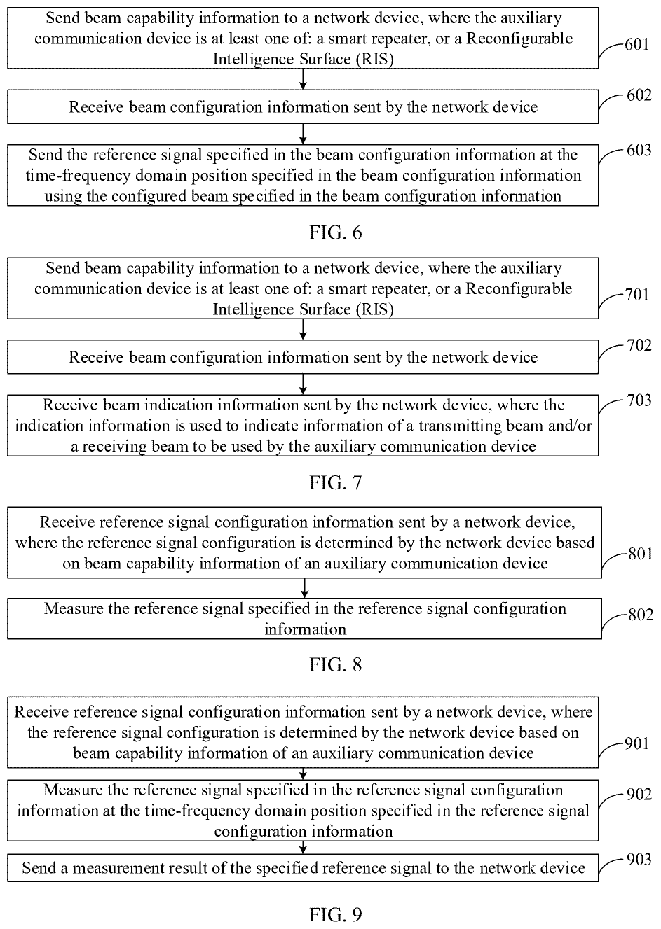

FIG. 6 is a flowchart of a beam information determination method provided by an embodiment of the present disclosure. The method is performed by an auxiliary communication device. As shown in FIG. 6, the method may include but is not limited to the following steps:

In step 601, beam capability information is sent to a network device. The auxiliary communication device is at least one of: a smart repeater, or a Reconfigurable Intelligence Surface (RIS).

In step 602, beam configuration information sent by the network device is received.

In the present disclosure, for the specific implementations of step 601 to step 602, reference may be made to the detailed description of any embodiment of the present disclosure, and repeated description will be omitted here.

In step 603, the reference signal specified in the beam configuration information is sent at the time-frequency domain position specified in the beam configuration information using the configured beam specified in the beam configuration information.

In the present disclosure, the auxiliary communication device can measure each configured beam specified in the beam configuration information to determine the channel state corresponding to each beam, thereby determining the beam with the best communication performance.

In the present disclosure, when the auxiliary communication device is a smart repeater, the auxiliary communication device can send the reference signal specified in the beam configuration information at the time-frequency domain position specified in the beam configuration information using the configured beam specified in the beam configuration information. The terminal device can receive the reference signal and measure the reference signal, and then send the measurement result to the network device, so that the network device can determine the beam with the best communication performance and indicate the auxiliary communication device to use the beam to perform communications.

In some embodiments of the present disclosure, when the auxiliary communication device is an RIS, the reference signal specified in the beam configuration information can be reflected at the time-frequency domain position specified in the beam configuration information using a phase shift matrix corresponding to the configured beam specified in the beam configuration information.

In some embodiments of the present disclosure, when the auxiliary communication device is an RIS, the reference signal specified in the beam configuration information may be transmitted at the time-frequency domain position specified in the beam configuration information using a phase shift matrix corresponding to the configured beam specified in the beam configuration information.

In the present disclosure, after sending the beam capability information to the network device, the auxiliary communication device can receive the beam configuration information sent by the network device, and then the auxiliary communication device can send the reference signal specified in the beam configuration information using the configured beam specified in the beam configuration information at the time-frequency domain position specified in the beam configuration information. Then, the terminal device can measure the reference signal. In this way, the network device can determine the beam with the best channel state according to the measurement result(s) reported by the terminal device, and indicate the auxiliary communication device to perform communications using the beam. Accordingly, the auxiliary communication device has a self-adaptive beamforming capability, thereby further improving the communication performance.

FIG. 7 is a flowchart of a beam information determination method provided by an embodiment of the present disclosure. The method is performed by an auxiliary communication device. As shown in FIG. 7, the method may include but is not limited to the following steps:

In step 701, beam capability information is sent to a network device. The auxiliary communication device is at least one of the following: a smart repeater, or a Reconfigurable Intelligence Surface (RIS).

In step 702, beam configuration information sent by the network device is received.

In the present disclosure, for the specific implementation of step 701 to step 702, reference may be made to the detailed description of any embodiment of the present disclosure, and repeated description will be omitted here.

In step 703, beam indication information sent by the network device is received. The indication information is used to indicate information of a transmitting beam and/or a receiving beam to be used by the auxiliary communication device.

The information of the beam to be used may be indicated by an associated reference signal, and the information of the beam to be used may include at least one of: an index of a reference signal, antenna port number of the reference signal, a time domain position occupied by the reference signal, a frequency domain position occupied by the reference signal, etc. In addition, the information of the beam to be used may be consistent with the configuration information of the reference signal in the beam configuration information corresponding to the beam.

In the present disclosure, after determining the information of the beam to be used, the network device can send to the auxiliary communication device the beam indication information of the transmitting beam and/or the receiving beam to be used by the auxiliary communication device. Thereafter, the auxiliary communication device can determine the beam to be used based on the beam indication information and the association information between the reference signal and the configured beam. Then, the auxiliary communication device can use the beam to perform communications and perform beamforming on the beam, thereby improving communication performance.

In the present disclosure, after sending beam capability information to the network device, the auxiliary communication device can receive beam configuration information sent by the network device, and then receive beam indication information sent by the network device to indicate the information of the transmitting beam and/or the receiving beam to be used by the auxiliary communication device. As a result, the network device can determine the beam with the best channel state through measurement based on the beam capability information sent by the auxiliary communication device, and indicate the auxiliary communication device to perform communications using the beam, thereby improving communication performance.

FIG. 8 is a flowchart of a beam information determination method provided by an embodiment of the present disclosure. The method is executed by a terminal device. As shown in FIG. 8, the method may include but is not limited to the following steps:

In step 801, reference signal configuration information sent by a network device is received. The reference signal configuration is determined by the network device based on beam capability information of an auxiliary communication device.

In addition, the reference signal configuration information includes at least one of: an index of a reference signal, antenna port number of the reference signal, a time domain position occupied by the reference signal, or a frequency domain position occupied by the reference signal.

In the present disclosure, after receiving the beam capability information sent by the auxiliary communication device, the network device can determine multiple beams with better communication performance. Afterwards, the network device can combine the multiple beams to determine the configured beam(s), and configure the corresponding reference signal for each configured beam, determine the reference signal configuration information, and then the network device can send the configuration information of each reference signal to the terminal device.

In some embodiments of the present disclosure, the network device may directly send the reference signal configuration information to the terminal device, or the network device may alternatively send the reference signal configuration information to the terminal device through an auxiliary communication device, which is not limited in the present disclosure.

In step 802, the reference signal specified in the reference signal configuration information is measured.

In the present disclosure, the terminal device can determine the reference signal according to the index of the reference signal in the reference signal configuration information, and then measure the reference signal to determine a beam measurement result corresponding to the reference signal. After that, the beam with the best channel state can be determined according to the measurement result.

In addition, the measurement quantity to be measured may include at least one of: Reference Signal Receiving Power (RSRP), Reference Signal Receiving Quality (RSRQ), Received Signal Strength Indicator (RSSI), or Signal to Interference plus Noise Ratio (SINR).

In the present disclosure, a terminal device can receive reference signal configuration information sent by a network device, and the reference signal configuration information is determined by the network device based on the beam capability information of an auxiliary communication device. After that, the reference signal specified in the reference signal configuration information can be measured, and the beam measurement result can be sent to the network device. Thus, the network device can determine the beam with the best channel state based on the measurement result reported by the terminal device, and indicate the auxiliary communication device to perform communications using the beam, thereby enabling the auxiliary communication device to have a self-adaptive beamforming capability, thereby further improving communication performance.

FIG. 9 is a flowchart of a beam information determination method provided by an embodiment of the present disclosure. The method is performed by a terminal device. As shown in FIG. 9, the method may include but is not limited to the following steps:

In step 901, reference signal configuration information sent by a network device is received. The reference signal configuration is determined by the network device based on beam capability information of an auxiliary communication device.

In the present disclosure, for the specific implementation of step 901, reference may be made to the detailed description of any embodiment of the present disclosure, and repeated description will be omitted here.

In step 902, the reference signal specified in the reference signal configuration information is measured at the time-frequency domain position specified in the reference signal configuration information.

In the present disclosure, the terminal device may measure each reference signal in the reference signal configuration information to determine the channel state of the beam corresponding to each reference signal.

In step 903, a measurement result of the specified reference signal is sent to the network device.

The measurement result of the reference signal may include at least one of: a measurement value of a measurement quantity, or reference signal configuration information corresponding to the measurement quantity. In addition, the measurement quantity may include at least one of: Reference Signal Receiving Power (RSRP), Reference Signal Receiving Quality (RSRQ), Received Signal Strength Indicator (RSSI), or Signal to Interference plus Noise Ratio (SINR).

In the present disclosure, after completing the measurement result of each reference signal, the terminal device can send the measurement result(s) to the network device. Thereafter, the network device can determine the channel state(s) of the beam(s) corresponding to the measurement result(s) based on the measurement result(s) reported by the terminal device, and determine the beam with the best channel state as the transmitting beam and/or the receiving beam to be used by the auxiliary communication device, thereby improving the communication performance.

In the present disclosure, after receiving the reference signal configuration information sent by the network device (the reference signal configuration information is determined by the network device based on the beam capability information of the auxiliary communication device), the terminal device can measure the reference signal specified in the reference signal configuration information at the time-frequency domain position specified in the reference signal configuration information. Thereafter, the measurement result of the specified reference signal can be sent to the network device. Thus, the network device can determine the beam with the best channel state based on the measurement result(s) reported by the terminal device, and indicate the auxiliary communication device to perform communications using the beam, thereby enabling the auxiliary communication device to have a self-adaptive beamforming capability, thereby further improving the communication performance.

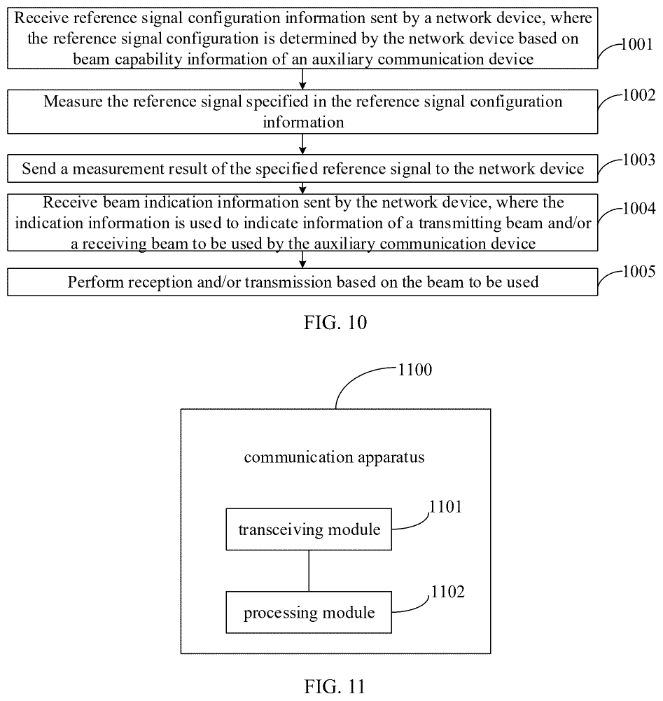

FIG. 10 is a flowchart of a beam information determination method provided by an embodiment of the present disclosure. The method is performed by a terminal device. As shown in FIG. 10, the method may include but is not limited to the following steps:

In step 1001, reference signal configuration information sent by a network device is received. The reference signal configuration is determined by the network device based on beam capability information of an auxiliary communication device.

In step 1002, the reference signal specified in the reference signal configuration information is measured.

In step 1003, a measurement result of the specified reference signal is sent to the network device.

In the present disclosure, for the specific implementation of step 1001 to step 1003, reference may be made to the detailed description of any embodiment in the present disclosure, and repeated description will be omitted here.

In step 1004, beam indication information sent by the network device is received. The indication information is used to indicate information of a transmitting beam and/or a receiving beam to be used by the auxiliary communication device.

In the present disclosure, the network device can determine the channel state corresponding to each beam according to the measurement result of each beam, and then determine the beam with the best channel state as the transmitting beam and/or the receiving beam to be used by the auxiliary communication device. The transmitting beam and/or the receiving beam to be used by the auxiliary communication device is the beam with the best channel state between the auxiliary communication device and the terminal device. Therefore, after determining the information of the beam to be used, the network device can send information indicating the transmitting beam and/or the receiving beam to be used by the auxiliary communication device to the terminal device, so that the terminal device also performs communications based on the beam to be used, thereby improving the communication performance.

In step 1005, reception and/or transmission is performed based on the beam to be used.

In the present disclosure, after receiving the reference signal configuration information which is sent by the network device and is determined by the network device based on the beam capability information of the auxiliary communication device, the terminal device can measure the reference signal specified in the reference signal configuration information and send the measurement result of the specified reference signal to the network device. After that, the terminal device can receive the beam indication information sent by the network device for indicating the information of the transmitting beam and/or the receiving beam to be used by the auxiliary communication device, and then the terminal device can perform reception and/or transmission based on the beam to be used. Thus, the network device can determine the beam with the best channel state according to the measurement result reported by the terminal device, and indicate the terminal device to perform communications using the beam, so that the auxiliary communication device has a self-adaptive beamforming capability, thereby further improving the communication performance.

FIG. 11 is a schematic diagram of the structure of a communication apparatus 1100 provided in an embodiment of the present disclosure. The communication apparatus 1100 shown in FIG. 11 may include a processing module 1101 and a transceiving module 1102. The transceiving module 1102 may include a sending module and/or a receiving module, the sending module is configured to implement a sending function, the receiving module is configured to implement a receiving function, and the transceiving module 1102 may implement a sending function and/or a receiving function.

It can be understood that the communication apparatus 1100 may be a network device, an apparatus in the network device, or an apparatus that can be used in conjunction with the network device.

The communication apparatus 1100 is applied at the network device side, wherein:

the transceiving module 1101 is configured to receive beam capability information sent by an auxiliary communication device, wherein the auxiliary communication device is at least one of: a smart repeater, or a Reconfigurable Intelligence Surface (RIS);

where the transceiving module 1101 is further configured to send beam configuration information to the auxiliary communication device.

In some embodiments of the present disclosure, the beam capability information includes at least one of:

information of an antenna panel or an RIS panel;

a beam adjustment capability;

the number of supported beams; and

angle information of each supported beam.

In some embodiments of the present disclosure, the information of the antenna panel or the RIS panel includes at least one of: direction information of the antenna panel or the RIS panel; or array element arrangement information of the antenna panel or the RIS panel.

In some embodiments of the present disclosure, the beam adjustment capability includes at least one of:

a frequency of beam adjustment, or time required to complete beam adjustment.

In some embodiments of the present disclosure, the beam configuration information includes at least one of:

information of a configured beam;

reference signal configuration information; or

association information between the reference signal and the configured beam.

In some embodiments of the present disclosure, the reference signal configuration information includes at least one of:

an index of a reference signal;

antenna port number of the reference signal;

a time domain position occupied by the reference signal; or

a frequency domain position occupied by the reference signal.

In some embodiments of the present disclosure, the transceiving module 1101 is further configured to:

send the reference signal configuration information to a terminal device.

In some embodiments of the present disclosure, the transceiving module 1101 is further configured to:

receive a beam measurement result sent by the terminal device.

In some embodiments of the present disclosure, the apparatus further includes:

the processing module 1101 configured to determine a transmitting beam and/or a receiving beam to be used by the auxiliary communication device;

where the processing module 1101 is further configured to send beam indication information to the auxiliary communication device and/or a terminal device, wherein the indication information is used to indicate information of the transmitting beam and/or the receiving beam to be used by the auxiliary communication device.

In some embodiments of the present disclosure, the processing module 1101 is further configured to:

determine a transmitting beam and/or a receiving beam to be used by the auxiliary communication device based on a beam measurement result sent by the terminal device; and/or

based on other information acquired by the network device, determine the transmitting beam and/or the receiving beam to be used by the auxiliary communication device is determined.

In some embodiments of the present disclosure, the information of the beam to be used is indicated by an associated reference signal, including at least one of:

an index of a reference signal;

antenna port number of the reference signal;

a time domain position occupied by the reference signal; or

a frequency domain position occupied by the reference signal.

In the present disclosure, after receiving the beam capability information sent by the auxiliary communication device, the network device can send beam configuration information to the auxiliary communication device. Thereafter, the auxiliary communication device can determine and send the corresponding reference signal according to the beam configuration information, so that the terminal device can measure the corresponding reference signal. Thus, the network device can determine the beam with the best channel state according to the measurement result(s) reported by the terminal device, and indicate the auxiliary communication device to perform communications using the beam. Accordingly, the auxiliary communication device has a self-adaptive beamforming capability, thereby further improving the communication performance.

It can be understood that the communication apparatus 1100 may be an auxiliary communication device, or an apparatus in the auxiliary communication device, or an apparatus that can be used in conjunction with the auxiliary communication device.

The communication apparatus 1100 is applied at the auxiliary communication device side.

The transceiving module 1101 is configured to send beam capability information to a network device, wherein the auxiliary communication device is at least one of: a smart repeater, or a Reconfigurable Intelligence Surface (RIS);

where the transceiving module 1101 is further configured to receive the beam configuration information sent by the network device.

In some embodiments of the present disclosure, the beam capability information includes at least one of:

information of an antenna panel or an RIS panel of the auxiliary communication device;

a beam adjustment capability;

the number of supported beams; and

angle information of each supported beam.

In some embodiments of the present disclosure, the information of the antenna panel or the RIS panel of the auxiliary communication device includes at least one of: direction information of the antenna panel or the RIS panel; or array element arrangement information of the antenna panel or the RIS panel.

In some embodiments of the present disclosure, the beam adjustment capability includes at least one of: a frequency of beam adjustment, or the time required to complete the beam adjustment.

In some embodiments of the present disclosure, the beam configuration information includes at least one of:

information of a configured beam;

reference signal configuration information; or

association information between the reference signal and the configured beam.

In some embodiments of the present disclosure, the reference signal configuration information includes at least one of:

an index of a reference signal;

antenna port number of the reference signal;

a time domain position occupied by the reference signal; or

a frequency domain position occupied by the reference signal.

In some embodiments of the present disclosure, the apparatus further includes a processing module 1101 configured to:

at a time-frequency domain position specified in the beam configuration information, send a reference signal specified in the beam configuration information using a configured beam specified in the beam configuration information; or

at a time-frequency domain position specified in the beam configuration information, reflect a reference signal specified in the beam configuration information using a phase shift matrix corresponding to a configured beam specified in the beam configuration information; or

at a time-frequency domain position specified in the beam configuration information, transmit a reference signal specified in the beam configuration information using a phase shift matrix corresponding to a configured beam specified in the beam configuration information.

In some embodiments of the present disclosure, the transceiving module 1101 is further configured to:

receive beam indication information sent by the network device, wherein the indication information is used to indicate information of a transmitting beam and/or a receiving beam to be used by the auxiliary communication device.

In some embodiments of the present disclosure, the information of the beam to be used is indicated by an associated reference signal, including at least one of:

an index of a reference signal;

antenna port number of the reference signal;

a time domain position occupied by the reference signal; or

a frequency domain position occupied by the reference signal.

In the present disclosure, after sending the beam capability information to the network device, the auxiliary communication device can receive the beam configuration information sent by the network device. Thereafter, the auxiliary communication device can determine and send the corresponding reference signal according to the beam configuration information, so that the terminal device can measure the corresponding reference signal. Thus, the network device can determine the beam with the best channel state according to the measurement result(s) reported by the terminal device, and indicate the auxiliary communication device to communicate using the beam. Accordingly, the auxiliary communication device has self-adaptive beamforming capability, thereby further improving the communication performance.

It can be understood that the communication apparatus 1100 can be a terminal device, an apparatus in the terminal device, or an apparatus that can be used in conjunction with the terminal device.

The communication apparatus 1100 is applied at the terminal device side.

The transceiving module 1101 is configured to receive reference signal configuration information sent by a network device, wherein the configuration of the reference signal is determined by the network device based on beam capability information of an auxiliary communication device.

The processing module 1102 is configured to measure the reference signal specified in the reference signal configuration information.

In some embodiments of the present disclosure, the reference signal configuration information includes at least one of:

an index of a reference signal;

antenna port number of the reference signal;

a time domain position occupied by the reference signal; or

a frequency domain position occupied by the reference signal.

In some embodiments of the present disclosure, the processing module 1102 is further configured to:

at a time-frequency domain position specified in the reference signal configuration information, measure a reference signal specified in the reference signal configuration information.

In some embodiments of the present disclosure, the transceiving module 1101 is further configured to:

send a measurement result of the specified reference signal to the network device.

In some embodiments of the present disclosure, the transceiving module 1101 is further configured to:

receive beam indication information sent by the network device, wherein the indication information is used to indicate information of a transmitting beam and/or a receiving beam to be used by the auxiliary communication device; and

perform reception and/or transmission based on the beam to be used.

In the present disclosure, the terminal device can receive the reference signal configuration information which is sent by the network device and is determined by the network device based on the beam capability information of the auxiliary communication device. After that, the reference signal specified in the reference signal configuration information can be measured, and the beam measurement result can be sent to the network device. Thus, the network device can determine the beam with the best channel state based on the measurement result(s) reported by the terminal device, and indicate the auxiliary communication device to perform communications using the beam, thereby enabling the auxiliary communication device to have a self-adaptive beamforming capability, thereby further improving communication performance.

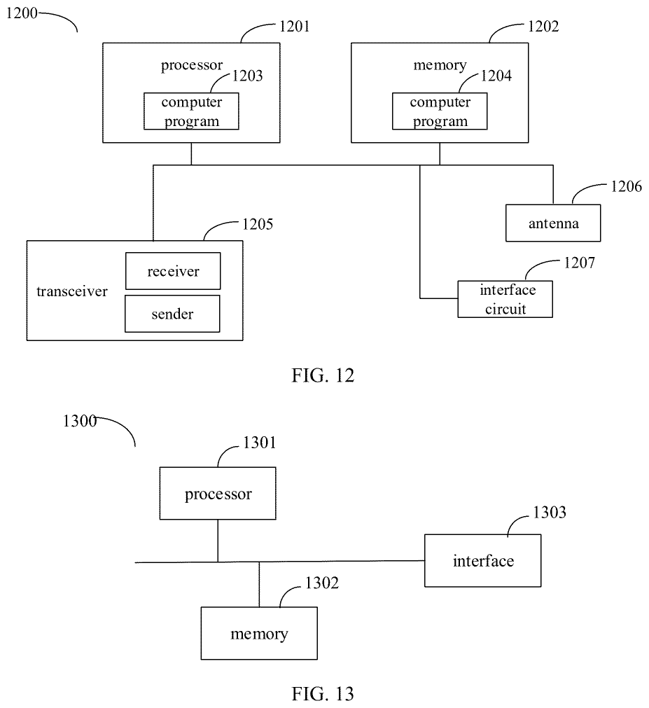

FIG. 12 is a schematic structural diagram of another communication apparatus 1200 provided by an embodiment of the present disclosure. The communication apparatus 1200 may be a network device, or an auxiliary communication device, or a terminal device, or a chip, a chip system or a processor that supports a network device to implement the above methods, or a chip, a chip system or a processor that supports an auxiliary communication device to implement the above methods, or a chip, a chip system or a processor that supports a terminal device to implement the above methods, etc. The apparatus may be configured to implement the methods described in the above method embodiments. For details, reference may be made to the descriptions in the above method embodiments.

The communication apparatus 1200 may include one or more processors 1201. The processor(s) 1201 may be a general-purpose processor or a special-purpose processor, etc. For example, it can be a baseband processor or a central processor. The baseband processor may be used to process communication protocols and communication data, and the central processor may be used to control the communication apparatus (such as base station, baseband chip, terminal device, terminal device chip, DU or CU, etc.), executes a computer program, and processes data for a computer program.

In some embodiments of the present disclosure, the communication apparatus 1200 may further include one or more memories 1202, on which a computer program 1204 may be stored, and the processor 1202 executes the computer program 1204, so that the communication apparatus 1200 performs the methods described in the above method embodiments. In some embodiments of the present disclosure, data may also be stored in the memory 1202. The communication apparatus 1200 and the memory 1202 may be provided separately or integrated together.

In some embodiments of the present disclosure, the communication apparatus 1200 may further include a transceiver 1205 and an antenna 1206. The transceiver 1205 may be called a transceiving unit, a transceiving device, or a transceiving circuit, etc., and is configured to realize sending and receiving functions. The transceiver 1005 may include a receiver and a sender. The receiver may be called a receiving device or a receiving circuit, etc., and is configured to realize the receiving function; the sender may be called a sending device or a sending circuit, etc., and is configured to realize the sending function.

In some embodiments of the present disclosure, the communication apparatus 1200 may further include one or more interface circuits 1207. The interface circuits 1207 are configured to receive code instructions and transmit them to the processor 1201. The processor 1201 executes the code instructions to cause the communication apparatus 1200 to perform the methods described in the above method embodiments.

The communication apparatus 1200 is a network device: the transceiver 1205 is configured to perform: step 305 in FIG. 3; step 403 in FIG. 4, etc.

The communication apparatus 1200 is an auxiliary communication device: the transceiver 1205 is configured to perform: steps 501 and 502 in FIG. 5; steps 601 and 602 in FIG. 6; steps 701, 702 and 703 in FIG. 7, etc.

The communication apparatus 1200 is a terminal device: the transceiver 1205 is configured to perform: step 801 and step 802 in FIG. 8; step 901 and step 903 in FIG. 9; step 1001, step 1003, step 1004 in FIG. 10, etc.

In one implementation, a transceiver for implementing receiving and sending functions may be included in the processor 1201. For example, the transceiver may be a transceiving circuit, or an interface, or an interface circuit. The transceiving circuit, interface or interface circuit configured to implement the receiving and sending functions may be separate or integrated together. The above-mentioned transceiving circuit, interface or interface circuit may be used for reading and writing of codes/data, or the above-mentioned transceiving circuit, interface or interface circuit may be used for signal transmission or delivery.

In one implementation, the processor 1201 may store a computer program 1203, and the computer program 1203 is run on the processor 1201, causing the communication apparatus 1200 to perform the methods described in the above method embodiments. The computer program 1203 may be solidified in the processor 1201, in which case the processor 1201 may be implemented in hardware.

In one implementation, the communication apparatus 1200 may include a circuit, and the circuit may implement the functions of sending or receiving or communicating in the foregoing method embodiments. The processor and transceiver described in the present disclosure may be implemented in Integrated Circuit (IC), analog IC, Radio Frequency Integrated Circuit (RFIC), mixed signal IC, Application Specific Integrated Circuit (ASIC), Printed Circuit Board (PCB), electronic device, and so on. The processor and transceiver may also be manufactured using various IC process technologies, such as Complementary Metal Oxide Semiconductor (CMOS), nMetal-Oxide-Semiconductor (NMOS), Positive Channel Metal Oxide Semiconductor (PMOS), Bipolar Junction Transistor (BJT), bipolar CMOS (BiCMOS), silicon germanium (SiGe), gallium arsenide (GaAs), etc.

The communication apparatus described in the above embodiments may be a network device, a terminal device or an auxiliary communication device, but the scope of the communication apparatus described in the present disclosure is not limited thereto, and the structure of the communication apparatus is not limited by FIG. 12. The communication apparatus may be a stand-alone device or may be part of a larger device. For example, the communication apparatus may be:

(1) an independent integrated circuit (IC), or a chip, or a chip system or subsystem;

(2) a collection of one or more ICs; in some embodiments of the present disclosure, the IC collection may further include a storage component for storing data and computer programs;

(3) ASIC, such as modem;

(4) a module that can be embedded in other device(s);

(5) a receiver, a terminal device, an intelligent terminal device, a cellular phone, a wireless device, a handheld device, a mobile unit, a vehicle-mounted device, a network device, a cloud device, an artificial intelligence device, etc.;

(6) others, etc.

For a case where the communication apparatus can be a chip or a chip system, please refer to the schematic diagram of the chip structure shown in FIG. 13. The chip shown in FIG. 13 includes a processor 1301 and an interface 1303. The number of processors 1301 may be one or more, and the number of interfaces 1303 may be more than one.

For a case where the chip is configured to implement the functions of the network device in the embodiments of the present disclosure:

The interface 1303 is configured to perform: step 201 in FIG. 2; steps 301, 302, 303, 304, and 306 in FIG. 3; steps 401, 402, and 404 in FIG. 4, etc.

For a case where the chip is configured to implement the functions of the auxiliary communication device in the embodiments of the present disclosure:

The interface 1303 is configured to perform: step 501 and step 502 in FIG. 5; step 601 and step 602 in FIG. 6; step 701, step 702, step 703 in FIG. 7, etc.

For a case where the chip is configured to implement the functions of the terminal device in the embodiments of the present disclosure:

The interface 1303 is configured to perform: step 801 and step 802 in FIG. 8; step 901 and step 903 in FIG. 9; step 1001, step 1003, step 1004 in FIG. 10, etc.

In some embodiments of the present disclosure, the chip further includes a memory 1303, and the memory 1303 is configured to store necessary computer programs and data. Further example embodiments are listed in as follows:

In an aspect, an embodiment of the present disclosure provides a beam information determination method. The method is performed by a network device, and the method includes:

receiving beam capability information sent by an auxiliary communication device, wherein the auxiliary communication device is at least one of: a smart repeater, or a Reconfigurable Intelligence Surface (RIS); and

sending beam configuration information to the auxiliary communication device.

Based on the beam information determination method provided by embodiments of the present disclosure, after receiving the beam capability information sent from the auxiliary communication device, the network device can send the beam configuration information to the auxiliary communication device. Thereafter, the auxiliary communication device can determine and send a corresponding reference signal according to the beam configuration information, so that a terminal device can measure the sent corresponding reference signal. Thus, the network device can determine the beam with the best channel state according to the measurement result reported by the terminal device, and indicate the auxiliary communication device to perform communicates using the beam. In this way, the auxiliary communication device has a self-adaptive beamforming capability, thereby further improving the communication performance.

In some embodiments of the present disclosure, the beam capability information includes at least one of:

information of an antenna panel or an RIS panel;

a beam adjustment capability;

the number of supported beams; and

angle information of each supported beam.

In some embodiments of the present disclosure, the information of the antenna panel or the RIS panel includes at least one of: direction information of the antenna panel or the RIS panel; or array element arrangement information of the antenna panel or the RIS panel.

In some embodiments of the present disclosure, the beam adjustment capability includes at least one of:

a frequency of beam adjustment; or time required to complete beam adjustment.

In some embodiments of the present disclosure, the beam configuration information includes at least one of:

information of a configured beam;

reference signal configuration information; or

association information between the reference signal and the configured beam.

In some embodiments of the present disclosure, the reference signal configuration information includes at least one of:

a reference signal index;

a reference signal antenna port number;

a time domain position occupied by a reference signal; or

a frequency domain position occupied by the reference signal.

In some embodiments of the present disclosure, the method further includes:

sending the reference signal configuration information to the terminal device.

In some embodiments of the present disclosure, the method further includes: receiving a beam measurement result sent by a terminal device.

In some embodiments of the present disclosure, the method further includes:

determining a transmitting beam and/or a receiving beam to be used by the auxiliary communication device; and

sending beam indication information to the auxiliary communication device and/or terminal device, wherein the indication information is used to indicate information of the transmitting beam and/or the receiving beam to be used by the auxiliary communication device.

In some embodiments of the present disclosure, the method further includes:

determining a transmitting beam and/or a receiving beam to be used by the auxiliary communication device based on the beam measurement result sent by the terminal device; and/or

based on other information acquired by the network device, determining the transmitting beam and/or the receiving beam to be used by the auxiliary communication device is determined.

In some embodiments of the present disclosure, the information of the beam to be used is indicated by an associated reference signal, including at least one of:

a reference signal index;

a reference signal antenna port number;

a time domain position occupied by the reference signal; or

a frequency domain position occupied by the reference signal.

In a further aspect, an embodiment of the present disclosure provides a beam information determination method. The method is performed by an auxiliary communication device, and the method includes:

sending beam capability information to a network device, wherein the auxiliary communication device is at least one of: a smart repeater, or a Reconfigurable Intelligence Surface (RIS); and

receiving beam configuration information sent by the network device.

Based on the beam information determination method provided by embodiments of the present disclosure, after sending the beam capability information to the network device, the auxiliary communication device can receive the beam configuration information sent by the network device. Thereafter, the auxiliary communication device can determine and send a corresponding reference signal according to the beam configuration information, so that the terminal device can measure the corresponding reference signal. Thus, the network device can determine the beam with the best channel state according to a measurement result reported by a terminal device, and indicate the auxiliary communication device to perform communicates using the beam. In this way, the auxiliary communication device has a self-adaptive beamforming capability, thereby further improving the communication performance.

In some embodiments of the present disclosure, the beam capability information includes at least one of:

information of an antenna panel or an RIS panel of the auxiliary communication device;

a beam adjustment capability;

the number of beams supported; and

angle information of each supported beam.

In some embodiments of the present disclosure, the information of the antenna panel or the RIS panel of the auxiliary communication device includes at least one of: direction information of the antenna panel or the RIS panel; or array element arrangement information of the antenna panel or the RIS panel.

In some embodiments of the present disclosure, the beam adjustment capability includes at least one of: a frequency of beam adjustment, or time required to complete beam adjustment.

In some embodiments of the present disclosure, the beam configuration information includes at least one of:

information of a configured beam;

reference signal configuration information; or

association information between a reference signal and the configured beam.

In some embodiments of the present disclosure, the reference signal configuration information includes at least one of:

a reference signal index;

a reference signal antenna port number;

a time domain position occupied by a reference signal; or

a frequency domain position occupied by the reference signal.

In some embodiments of the present disclosure, the method further includes:

at a time-frequency domain position specified in the beam configuration information, sending a reference signal specified in the beam configuration information using a configured beam specified in the beam configuration information; or

at a time-frequency domain position specified in the beam configuration information, reflecting a reference signal specified in the beam configuration information using a phase shift matrix corresponding to a configured beam specified in the beam configuration information; or

at a time-frequency domain position specified in the beam configuration information, transmitting a reference signal specified in the beam configuration information using a phase shift matrix corresponding to a configured beam specified in the beam configuration information.

In some embodiments of the present disclosure, the method further includes:

receiving beam indication information sent by the network device, wherein the indication information is used to indicate information of a transmitting beam and/or a receiving beam to be used by the auxiliary communication device.

In some embodiments of the present disclosure, the information of the beam to be used is indicated by an associated reference signal, including at least one of: a reference signal index;

a reference signal antenna port number;

a time domain position occupied by the reference signal; or

a frequency domain position occupied by the reference signal.

In a further aspect, an embodiment of the present disclosure provides a beam information determination method. The method is performed by a terminal device, and the method includes:

receiving reference signal configuration information sent by a network device, wherein the configuration of the reference signal is determined by the network device based on beam capability information of an auxiliary communication device; and

measuring the reference signal specified in the reference signal configuration information.

Based on the beam information determination method provided by embodiments of the present disclosure, the terminal device can receive, from the network device, reference signal configuration information which is determined by the network device based on the beam capability information of the auxiliary communication device. Thereafter, the reference signal specified in the reference signal configuration information can be measured, and a beam measurement result can be sent to the network device. Thus, the network device can determine the beam with the best channel state based on the measurement result reported by the terminal device, and indicate the auxiliary communication device to perform communicates using the beam. In this way, the auxiliary communication device can have a self-adaptive beamforming capability, thereby further improving communication performance.

In some embodiments of the present disclosure, the reference signal configuration information includes at least one:

a reference signal index;

a reference signal antenna port number;

a time domain position occupied by a reference signal; or a frequency domain position occupied by the reference signal.

In some embodiments of the present disclosure, the method further includes:

at a time-frequency domain position specified in the reference signal configuration information, measuring the reference signal specified in the reference signal configuration information.

In some embodiments of the present disclosure, the method further includes:

sending a measurement result of the specified reference signal to the network device.

In some embodiments of the present disclosure, the measurement result of the reference signal includes at least one of: a measurement value of a measurement quantity; or reference signal configuration information corresponding to the measurement quantity.

In some embodiments of the present disclosure, the method further includes:

receiving beam indication information sent by the network device, wherein the indication information is used to indicate information of a transmitting beam and/or a receiving beam to be used by the auxiliary communication device; and

performing reception and/or transmission based on the beam to be used.

In a further aspect, an embodiment of the present disclosure provides a communication apparatus, applied at a network device side. The apparatus includes:

a transceiving module configured to receive beam capability information sent by an auxiliary communication device, wherein the auxiliary communication device is at least one of: a smart repeater, or a Reconfigurable Intelligence Surface (RIS);

where the transceiving module is further configured to send beam configuration information to the auxiliary communication device.

In some embodiments of the present disclosure, the beam capability information includes at least one of:

information of an antenna panel or an RIS panel;

a beam adjustment capability;

the number of supported beams; and

angle information of each supported beam.

In some embodiments of the present disclosure, the information of the antenna panel or the RIS panel includes at least one of: direction information of the antenna panel or the RIS panel; or array element arrangement information of the antenna panel or the RIS panel.

In some embodiments of the present disclosure, the beam adjustment capability includes at least one of:

a frequency of beam adjustment, or time required to complete beam adjustment.

In some embodiments of the present disclosure, the beam configuration information includes at least one of:

information of a configured beam;

reference signal configuration information; or

association information between the reference signal and the configured beam.

In some embodiments of the present disclosure, the reference signal configuration information includes at least one of:

a reference signal index;

a reference signal antenna port number;

a time domain position occupied by a reference signal; or

a frequency domain position occupied by the reference signal.

In some embodiments of the present disclosure, the transceiving module is further configured to:

send the reference signal configuration information to a terminal device.

In some embodiments of the present disclosure, the transceiving module is further configured to:

receive a beam measurement result sent by the terminal device.

In some embodiments of the present disclosure, the apparatus further includes:

a processing module configured to determine a transmitting beam and/or a receiving beam to be used by the auxiliary communication device;

where the processing module is further configured to send beam indication information to the auxiliary communication device and/or a terminal device, wherein the indication information is used to indicate information of the transmitting beam and/or the receiving beam to be used by the auxiliary communication device.

In some embodiments of the present disclosure, the processing module is further configured to:

determine a transmitting beam and/or a receiving beam to be used by the auxiliary communication device based on a beam measurement result sent by the terminal device; and/or

based on other information acquired by the network device, determine the transmitting beam and/or the receiving beam to be used by the auxiliary communication device is determined.

In some embodiments of the present disclosure, the information of the beam to be used is indicated by an associated reference signal, including at least one of:

a reference signal index;

a reference signal antenna port number;

a time domain position occupied by the reference signal; or

a frequency domain position occupied by the reference signal.

In a further aspect, an embodiment of the present disclosure provides a communication apparatus, applied at an auxiliary communication device side. The apparatus includes:

a transceiving module configured to send beam capability information to a network device, wherein the auxiliary communication device is at least one of: a smart repeater, or a Reconfigurable Intelligence Surface (RIS);

where the transceiving module is further configured to receive the beam configuration information sent by the network device.

In some embodiments of the present disclosure, the beam capability information includes at least one of:

information of an antenna panel or an RIS panel of the auxiliary communication device;

a beam adjustment capability;

the number of supported beams; and

angle information of each supported beam.

In some embodiments of the present disclosure, the information of the antenna panel

or the RIS panel of the auxiliary communication device includes at least one of: direction information of the antenna panel or the RIS panel; or array element arrangement information of the antenna panel or the RIS panel.

In some embodiments of the present disclosure, the beam adjustment capability includes at least one of: a frequency of beam adjustment, or the time required to complete the beam adjustment.

In some embodiments of the present disclosure, the beam configuration information includes at least one of:

information of a configured beam;

reference signal configuration information; or

association information between the reference signal and the configured beam.

In some embodiments of the present disclosure, the reference signal configuration information includes at least one of:

a reference signal index;

a reference signal antenna port number;

a time domain position occupied by a reference signal; or

a frequency domain position occupied by the reference signal.

In some embodiments of the present disclosure, the apparatus further includes a processing module configured to:

at a time-frequency domain position specified in the beam configuration information, send a reference signal specified in the beam configuration information using a configured beam specified in the beam configuration information; or

at a time-frequency domain position specified in the beam configuration information, reflect a reference signal specified in the beam configuration information using a phase shift matrix corresponding to a configured beam specified in the beam configuration information; or

at a time-frequency domain position specified in the beam configuration information, transmit a reference signal specified in the beam configuration information using a phase shift matrix corresponding to a configured beam specified in the beam configuration information.

In some embodiments of the present disclosure, the transceiving module is further configured to:

receive beam indication information sent by the network device, wherein the indication information is used to indicate information of a transmitting beam and/or a receiving beam to be used by the auxiliary communication device.

In some embodiments of the present disclosure, the information of the beam to be used is indicated by an associated reference signal, including at least one of:

a reference signal index;

a reference signal antenna port number;

a time domain position occupied by the reference signal; or

a frequency domain position occupied by the reference signal.

In a further aspect, an embodiment of the present disclosure provides a communication apparatus, applied at a terminal device side. The apparatus includes:

a transceiving module configured to receive reference signal configuration information sent by a network device, wherein the configuration of the reference signal is determined by the network device based on beam capability information of an auxiliary communication device; and

a processing module configured to measure the reference signal specified in the reference signal configuration information.

In some embodiments of the present disclosure, the reference signal configuration information includes at least one of:

a reference signal index;

a reference signal antenna port number;

a time domain position occupied by a reference signal; or

a frequency domain position occupied by the reference signal.

In some embodiments of the present disclosure, the processing module is further configured to:

at a time-frequency domain position specified in the reference signal configuration information, measure a reference signal specified in the reference signal configuration information.

In some embodiments of the present disclosure, the transceiving module is further configured to:

send a measurement result of the specified reference signal to the network device.

In some embodiments of the present disclosure, the transceiving module is further configured to:

receive beam indication information sent by the network device, wherein the indication information is used to indicate information of a transmitting beam and/or a receiving beam to be used by the auxiliary communication device; and perform reception and/or transmission based on the beam to be used.

In a further aspect, an embodiment of the present disclosure provides a system. The system includes the communication apparatuses described in the above aspects.

The various illustrative logical blocks and steps listed in the embodiments of the present disclosure may be implemented by electronic hardware, computer software, or a combination of both. Whether such functionality is implemented in hardware or software depends on the specific application and overall system design requirements. In some embodiments, various methods may be used to implement the described functions for each specific application, but such implementation should not be understood as beyond the scope of protection of the embodiments of the present disclosure.

The present disclosure also provides a readable storage medium on which instructions are stored, and when the instructions are executed by a computer, the functions of any of the above method embodiments are implemented.

The present disclosure also provides a computer program product, which, when executed by a computer, implements the functions of any of the above method embodiments.

The above embodiments may be implemented in whole or in part by software, hardware, firmware, or any combination thereof. When implemented in software, the embodiments may be implemented in whole or in part in the form of a computer program product. The computer program product includes one or more computer programs. When the computer program is loaded and executed on a computer, processes or functions described in accordance with the embodiments of the present disclosure are generated in whole or in part. The computer may be a general-purpose computer, a special-purpose computer, a computer network, or other programmable device. The computer program may be stored in a computer-readable storage medium, or may be transferred from one computer-readable storage medium to another, for example, the computer program may be transferred from a website, computer, server, or data center to another website, computer, server or data center through wired (such as coaxial cable, optical fiber, Digital Subscriber Line (DSL)) or wireless (such as infrared, wireless, microwave, etc.) means. The computer-readable storage medium may be any available medium that can be accessed by a computer or a data storage device such as a server, data center, etc. that contains one or more available media integrated. The available medium may be magnetic medium (for example, floppy disk, hard disk, magnetic tape), optical medium (for example, high-density Digital Video Disc (DVD)), or semiconductor medium (for example, Solid State Disk (SSD)), etc.

Those of ordinary skill in the art can understand that first, second, and other numerical numbers involved in the present disclosure are only for convenience of description and are not used to limit the scope of the embodiments of the disclosure, nor to indicate a sequential order.

The term “at least one” in the present disclosure can also be described as one or a plurality of, and the plurality can be two, three, four or more, and the present disclosure is not limited thereto. In the embodiments of the present disclosure, for a kind of technical features, “first”, “second”, “third”, “A”, “B”, “C” and “D”, etc. are used to distinguish technical features in the kind of technical features, and technical features described associated with “first”, “second”, “third”, “A”, “B”, “C” and “D” are in no particular sequential order or order of size.

The corresponding relationships shown in each table in the present disclosure can be configured or predefined. Value(s) of information in each table is (are) only examples and can be configured as other values, which is not limited by the present disclosure. When configuring a corresponding relationship between information and each parameter, it is not necessarily required to configure all the corresponding relationships shown in each table. For example, in a table in the present disclosure, a corresponding relationship shown in some rows may not be configured. For another example, appropriate modified adjustments can be made based on the above table, such as splitting, merging, etc. Names of parameters shown in titles of the tables may also be other names understandable by a communication apparatus, and values or expressions of parameters may also be other values or expressions understandable by the communication apparatus. When implementing the tables, other data structures can also be used, such as arrays, queues, containers, stacks, linear lists, pointers, linked lists, trees, graphs, structure bodies, classes, heaps, hash tables or lists, and so on.

Predefinition in the present disclosure may be understood as definition, definition in advance, storage, pre-storage, pre-negotiation, pre-configuration, solidification, or pre-burning.

In some embodiments, the units and algorithm steps of each example described in conjunction with the embodiments disclosed herein may be implemented with electronic hardware, or a combination of computer software and electronic hardware. Whether these functions are performed in hardware or software depends on the specific application and design constraints of the technical solutions. Skilled artisans may implement the described functions using different methods for each specific application, but such implementations should not be considered to be beyond the scope of the present disclosure.

For the convenience and simplicity of description, the specific working processes of the systems, apparatuses and units described above can be referred to the corresponding processes in the foregoing method embodiments, and will not be described again here. The above are only example embodiments of the present disclosure, but the protection scope of the present disclosure is not limited thereto. Any person familiar with the technical field can easily think of changes or substitutions within the technical scope disclosed in the present disclosure, and such changes or substitutions fall within the protection scope of the present disclosure. Therefore, the protection scope of the present disclosure should be determined by the appended claims.

1. A beam information determination method, comprising:
receiving, by a network device, beam capability information sent by an auxiliary communication device, wherein the auxiliary communication device is at least one of: a smart repeater, or a Reconfigurable Intelligence Surface (RIS); and
sending, by the network device, beam configuration information to the auxiliary communication device.

2. The method according to claim 1, wherein the beam capability information comprises at least one of:
information of an antenna panel or an RIS panel;
a beam adjustment capability;
a number of supported beams; or
angle information of each supported beam.

3. The method according to claim 2, wherein the information of the antenna panel or the RIS panel comprises at least one of: direction information of the antenna panel or the RIS panel; or element arrangement information of the antenna panel or the RIS panel.

4. The method according to claim 2, wherein the beam adjustment capability comprises at least one of:
a frequency of beam adjustment, or time required to complete beam adjustment.

5. The method according to claim 1, wherein the beam configuration information comprises at least one of:
information of a configured beam;
reference signal configuration information; or
association information between a reference signal and a configured beam.

6. The method according to claim 5, wherein the reference signal configuration information comprises at least one of:
an index of a reference signal;
antenna port number of a reference signal;
a time domain position occupied by a reference signal; or
a frequency domain position occupied by a reference signal.

7. The method according to claim 6, further comprising:
sending, by the network device, the reference signal configuration information to a terminal device.

8. The method according to claim 7, further comprising:
receiving, by the network device, a beam measurement result sent by the terminal device.

9. The method according to claim 1, further comprising:
determining, by the network device, at least one beam of a transmitting beam or a receiving beam to be used by the auxiliary communication device; and
sending, by the network device, beam indication information to at least one of the auxiliary communication device of a terminal device, wherein the indication information is configured to indicate information of the at least one beam to be used by the auxiliary communication device.

10. The method according to claim 9, further comprising: determining, by the network device, the at least one beam based on at least one of: a beam measurement result sent by the terminal device, or information acquired by the network device.

11. The method according to claim 9, wherein the information of the at least one beam is indicated by an associated reference signal, and the information of the at least one beam comprises at least one of:
an index of a reference signal;
antenna port number of a reference signal;
a time domain position occupied by a reference signal; or
a frequency domain position occupied by a reference signal.

12. A beam information determination method, comprising:
sending, by an auxiliary communication device, beam capability information to a network device, wherein the auxiliary communication device is at least one of: a smart repeater, or a Reconfigurable Intelligence Surface (RIS); and
receiving, by the auxiliary communication device, beam configuration information sent by the network device.

13. The method according to claim 12, wherein the beam capability information comprises at least one of:
information of an antenna panel or an RIS panel of the auxiliary communication device;
a beam adjustment capability;
a number of supported beams; or
angle information of each supported beam.

14-20. (canceled)

21. A beam information determination method, comprising:
receiving, by a terminal device, reference signal configuration information sent by a network device, wherein the configuration of the reference signal configuration information is determined by the network device based on beam capability information of an auxiliary communication device, and the auxiliary communication device is at least one of: a smart repeater, or a Reconfigurable Intelligence Surface (RIS); and
measuring, by the terminal device, a reference signal specified in the reference signal configuration information.

22-52. (canceled)

53. A communication apparatus, comprising a processor and a memory, wherein the memory stores a computer program, and the processor is configured to execute the computer program stored in the memory to cause the apparatus to perform the method according to claim 1.

54. A non-transitory computer-readable storage medium storing instructions, wherein when the instructions are executed, the method according to claim 1 is implemented.

55. A communication apparatus, comprising a processor and a memory, wherein the memory stores a computer program, and the processor is configured to execute the computer program stored in the memory to cause the apparatus to perform the method according to claim 12.

56. A communication apparatus, comprising a processor and a memory, wherein the memory stores a computer program, and the processor is configured to execute the computer program stored in the memory to cause the apparatus to perform the method according to claim 21.

57. A non-transitory computer-readable storage medium storing instructions, wherein when the instructions are executed, the method according claim 12 is implemented.

58. A non-transitory computer-readable storage medium storing instructions, wherein when the instructions are executed, the method according claim 21 is implemented.
